(19) United States
(12) Patent Application Publication
(10) Pub. No.: US 2024/0076071 A1
(43) Pub. Date: Mar. 7, 2024

(54) AERIAL VEHICLE ALSO CAPABLE OF MOVING ON INCLINED SURFACES

(71) Applicant: B.G. NEGEV TECHNOLOGIES & APPLICATIONS LTD., AT BEN-GURION UNIVERSITY, Beer-Sheva (IL)

(72) Inventor: David ZARROUK, Haifa (IL)

(21) Appl. No.: 18/370,413

(22) Filed: Sep. 20, 2023

Related U.S. Application Data
(63) Continuation-in-part of application No. PCT/IL2022/050250, filed on Mar. 7, 2022.
(60) Provisional application No. 63/163,880, filed on Mar. 21, 2021.

(51) Int. Cl. B64U 60/55; A47L 1/02; B64U 10/60; B64U 50/13

(52) U.S. Cl. CPC B64U 60/55; A47L 1/02; B64U 10/60; B64U 50/13; B64U 2101/29

(57) ABSTRACT

A flying driving vehicle having a body, a driving interface coupled to the body configured to enable the body to drive on a surface, and one or more driving actuators configured to provide power to the driving interface, a set of propellers coupled to the body, where the propellers' movement keeps the vehicle in place when the surface is in slope, and a controller for controlling the speed of the driving interface, a rotation speed of the set of propellers and a magnitude and direction of thrust applied by the set of propellers.

### FIELD

The invention relates to aerial vehicles, more specifically to aerial vehicles also capable of moving on inclined surfaces.

### BACKGROUND

The requirement for automated window cleaning system for skyscrapers and solar panels has been increasing along the years. An increasing number of large building with more than 20 stories are built all over the world. These buildings generally have large window facets which require cleaning usually twice a year. In parallel, the use of solar panels, fueled by the desire to produce clean energy has been increasing. Multiple large solar power plants spreading over multiple square kilometers have been developed in recent years. These plants also require cleaning and maintenance to maintain their high energy efficiency.

Robots are also used for cleaning building windows, which are typically vertical. Currently, they are cleaned by cleaning companies who hire professional highly trained human washers. The workers generally descend from the top of the building using rock climbing like gear. The workers are required to have no height fear and be physically capable. In recent years, multiple robots were developed to clean windows. Although multiple intelligent designs were suggested, these robots are not yet deployed at large scales due the complexity of their deployment in real life scenarios. These robots include cable robots, crawling robots with suction systems, flying drones and other designs. “Wall robotics” introduced a cable robot attached to the building by multiple cables and relies on propellers to increase the forces it applies on the windows. The robot requires multiple anchoring points for the walls and its accuracy is limited by the cable's tension. The robot has passive wheels above its propellers. When inverted, it can stick to the wall and roll using its passive wheels. A drone developed by Aerones can fly near the building and clean the windows using liquids supplied by a tether. However, the drone does not tilt its body to drive over the building.

Solar panels are generally tilted to maximize the energy absorbed from the sun based on one's geographic location. The optimum tilt angle is calculated by adding 15 degrees to the latitude during winter, and subtracting 15 degrees from the latitude during summer. For example, if the latitude is 30°, the optimum tilt angle of the panels during winter will be 45° and 15° during summer. For 45° latitude, the solar panels must be tilted by 30° to 60° in summer and winter respectively. Slopes of 20° and more are extremely challenging to drive on, for example using driving wheels.

Multiple robots were designed to clean panels. Some of which (based on traditional technologies) are attached to solar panels frames are already available for market usage. These robots are limited as their maintenance is required to be performed on premise. Other robots are mobile and drive on the panels while cleaning them. However, they have a limited level of maneuverability over highly sloped panels and cannot move from one panel to another or to a central base. Flying drones have also been suggested for cleaning panels. For example, Aerial Power and Hercules 10 drone clean the panels by flying near them without landing, and without moving on the surfaces. Using this strategy, the drone will have localization difficulties, especially in windy condition and cannot apply forces on the panels. These robots are also limited in terms of the forces they can apply on the panels while cleaning them.

Multiple designs of flying driving drones with active driving wheels were designed but neither has been developed to drive over slopes or vertical surfaces. Flying STAR robot comprises wheels at its bottom and is capable of taking off and driving. Flying-driving drones were also developed for leisure purposes (toys). Among them are JJRC H23 and Syma x9, both of which are available for sale. A collaboration between Disney labs and EPFL yielded “Vertigo” robot which has passive wheels and rotates its propellers to advance on ground and walls. The Vertigo robot, although fitted with two propellers, is not designed to fly. No flying driving drones were suggested for cleaning panels or windows.

### SUMMARY

In one aspect of the invention a driving-flying device is provided having driving wheels or tracks and propellers. The device may be used for cleaning windows, solar panels and rooftops, or for inspection. The device comprises a flight controller that allows it to reverse the rotation direction of its propellers. Using its propellers and wheels/tracks, the device can fly like a regular quadcopter and drive over surfaces. When driving over an inclined or vertical surface, the robot can reverse the thrust direction of the propellers to provide negative thrust (forces from top to bottom). The negative thrust is essential to increase the engagement (normal) forces and friction forces of the device with the surface it is driving or standing on. As a result, the device can drive over inclined surfaces such as solar panels and even drive vertically over vertical windows. The device can also be used for cleaning the external parts of building and rooftops such as the roof and train stations.

In another aspect of the invention a flying driving vehicle is provided, comprising a body, a driving interface coupled to the body, configured to enable the body to drive on a surface and a driving actuator configured to provide power to the driving interface, a set of propellers coupled to the body, wherein the propellers' movement keep the vehicle in place when the surface is inclined relative to the ground, a controller for controlling the speed of the driving interface, a rotation speed of the set of propellers and a magnitude and direction of thrust applied by the set of propellers.

In some cases, the driving interface is a caterpillar track. In some cases, the driving interface is a set of wheels. In some cases, the flying driving vehicle further comprising a cleaning module coupled to the body. In some cases, the cleaning module comprises one or more rotating brushes. In some cases, the cleaning module comprises one or more brushes that move linearly along with the body.

In some cases, the cleaning module comprises a container configured to output a cleaning material. In some cases, the cleaning module is removable from the body.

In some cases, the flying driving vehicle further comprising a motion sensor for collecting movement measurements of the aerial vehicle when in contact with the surface, wherein the controller sets a speed of the set of propellers according to the collected measurements, the propellers' movement prevents the driving interface from sliding from the surface.

In some cases, the motion sensor is an accelerometer. In some cases, the motion sensor is a gyroscope. In some cases, the motion sensor is a magnetometer. In some cases, the motion sensor is an altimeter.

In some cases, the flying driving vehicle further comprising a the set of propellers actuators, each propeller actuator of the set of propeller actuator is coupled to the controller and outputs power according to a command from the controller.

In some cases, the flying driving vehicle further comprising a detection sensor for detecting an environment of the flying driving vehicle.

In some cases, the flying driving vehicle further comprising a tether coupled to the body for securing the flying driving vehicle to another object.

In some cases, the flying driving vehicle further comprising a push-pull mechanism for extending and shortening a length of the tether.

In some cases, the tether is a tube capable of carrying an object selected from liquids, cleaning equipment, communication equipment and a combination thereof.

In some cases, at least some of the propellers in the set of propellers are used for flying the vehicle and applying the negative thrust.

In another aspect of the invention a method is provided for moving a flying driving vehicle on a sloped surface, the method comprising collecting motion measurements indicating that the flying driving vehicle drives on the sloped surface to a degree not required by a controller, activating propellers coupled to the flying driving vehicle such that the propellers output thrust force that stop the driving motion on the sloped surface.

In some cases, the method further comprising gradually reducing the thrust force provided by the set of propellers until reaching a minimal thrust force that enables driving to a degree required by the controller.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a flying driving vehicle capable of moving on a sloped surface using wheels, according to exemplary embodiments of the present invention;

FIG. 2 shows a flying driving vehicle capable of moving on a sloped surface using tracks, according to exemplary embodiments of the present invention;

FIGS. 3A-3B show a flying driving vehicle capable of moving on a sloped surface using wheels at various directions, according to exemplary embodiments of the present invention;

FIGS. 4A-4B show a flying driving vehicle capable of moving on a sloped surface using wheels at various patterns, according to exemplary embodiments of the present invention;

FIGS. 5A-5C show a flying driving vehicle coupled to a tether when cleaning a building, according to exemplary embodiments of the present invention;

FIG. 6 shows a flying driving vehicle producing both positive and negative thrust, according to exemplary embodiments of the present invention;

FIG. 7 shows a flying driving vehicle having a force sensor, according to exemplary embodiments of the present invention;

FIGS. 8A-8B show a flying driving vehicle having a force sensor coupled to the longitudinal arms of the vehicle, according to exemplary embodiments of the present invention;

FIGS. 9A-9B show a flying driving vehicle hanging from a tether, according to exemplary embodiments of the present invention; and

FIGS. 10A-10D show a flying driving vehicle landing on an inclined surface, according to exemplary embodiments of the present invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

In one aspect of the invention a driving-flying aerial vehicle is provided, comprising a body; a driving interface coupled to the body, configured to enable the body to drive on a surface; a set of propellers coupled to the body; wherein the propellers' movement keep the driving interface in place when the surface is in slope; a controller for controlling the speed of the driving interface and the speed and a thrust direction applied by the set of propellers. The driving interface may be wheels or tracks, or both.

The driving-flying aerial vehicle may be an autonomous robot configured to execute missions, such as cleaning, detection, transport of object and the like. The driving-flying aerial vehicle, also defined hereinafter as “the device”, “the vehicle”, “the robot”, is capable of driving over inclined surfaces by applying negative thrust using the set of propellers. This ability allows the robot to efficiently clean inclined surfaces, such as solar panels, by flying to the specific panels which require cleaning and return to base for recharging and maintenance when required. The robot can both move on the cleaned surface and fly from one solar panel to another in an efficient manner.

The vehicle comprises a set of propellers coupled to the vehicle's body. The number of propellers may be selected by a designer of the vehicle. In some cases, each propeller in the set of propellers may be actuated by a separate driving actuator or motor. The driving mechanism, such as a pair of tracks or multiple driving wheels, may be actuated by a single driving actuator or motor. Rotating the wheels around their rotation axis may be done by a separate motor. The selection between wheels or tracks may depend on properties such as the surface's rigidity, presence of obstacles, waste, dirt or debris. The vehicle may carry cleaning equipment, such as brushes, cleaning liquid, cleaning powder, paste and the like. The vehicle may carry inspection equipment such as cameras, GPS, optoelectronics sensors, and other navigation and localization sensors.

The vehicle is configured to be able to fly and to drive on a surface. When flying, the vehicle uses a set of rotating propellers like a standard drone. The thrust direction of the propellers is reversible, enabling the vehicle to produce thrust upwards or downwards without inverting the body's orientation (without placing the body upside-down). Changing the thrust direction may be performed by changing a direction of the propellers' rotational movement, for example from clockwise to counterclockwise. Changing the thrust direction may be also performed by changing the pitch angle of the propeller using a swashplate and an onboard actuator such as a servo motor. The vehicle comprises a driving mechanism configured to enable the vehicle to move along surfaces, the surfaces may be inclined relative to the ground, such as solar panels, windows and the like, for example in the range of 5-90 degrees relative to the ground. The driving mechanism may be tracks located on an bottom part of the vehicle, such that the body of the vehicle is not in physical contact with the surface. In some cases, the vehicle comprises a pair of tracks, each track is actuated by a separate motor. In such case, the vehicle may rotate by driving the tracks at different speeds.

The driving mechanism may be driving wheels. In some cases, all the wheels may can be actuated using a single motor to decrease the size and weight of the vehicle and simplify the vehicle's control. The wheels may be phased together and synchronized, in a manner that all the wheels' rotation axes are parallel. This way, the vehicle can drive in any desired direction. In some other cases, the wheels may be omni drive wheels, such that each of the wheels is actuated by a separate motors.

The vehicle comprises a flight controller for controlling the vehicle's movements. The controller controls the propellers' speed, the driving mechanism speed and direction, and a thrust direction of the propellers. The controller may send commands to change the thrust direction, for example by reversing the propellers' rotation direction or angle of the propellers' blades relative to the body. Changing the thrust direction enables the controller to increase the vertical force applied towards the surface.

The vehicle can identify its location on the surface and program its driving path using localization method such as real time kinematic positioning, visual analysis (image processing), or other methods and techniques selected by a person skilled in the art. The vehicle may comprise one or more sensors, such as cameras, sensors for measuring a doppler effect, proximity sensors, thermal sensors and the like, which can be stored on the system memory or relayed in real time to the vehicle's operator.

The vehicle may comprise a suction module coupled to the vehicle's body. The suction module is configured to suck air. The distal end of the suction module may be near the surface, for example on a bottom part of the vehicle, close to the wheels or the track. The suction module increases the vehicle's grip on the surface by generating a vacuum-like field at the surface on which the vehicle moves or hangs.

In some cases, the vehicle may comprise a tether. The tether may be secured, roller in a specific compartment or area in the vehicle when the tether is not used, and released when used. The tether may be used to carry the vehicle, for safety and stability. The vehicle may be tethered to a base. The base may be static or movable. The tether enables the vehicle to be anchored on vertical or nearly vertical surfaces while the tether holds the vehicle's weight. The tether may also increase the safety of the system in case the vehicle loses control over its location because of malfunctioning, high speed winds, or other unexpected debris. The tether can also supply the robot with electrical power and serve as a communication cable, for example to transmit commands, video imaging, and other sensory data. Third, the tether can supply the drone with cleaning material such as washing liquids.

By actuating its four propellers, the robot can substantially increase its hold with the surface. When driving over an inclined surface such as a solar panel, each of the propellers applies a negative thrust force (downwards). In order to stick to the surface, the sum of the friction forces of the wheels and the cleaning brushes is required to be larger than the weight component parallel to the surface.

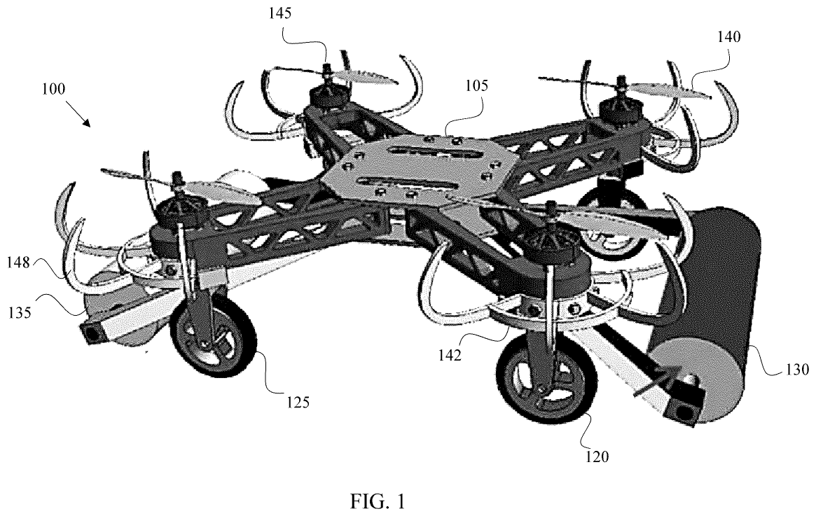

FIG. 1 shows a flying driving vehicle capable of moving on a sloped surface using wheels, according to exemplary embodiments of the present invention. The flying driving vehicle, also defined below as vehicle 100, comprises a body 105. The body 105 may be assembled of metals, polymers and additional materials. The body 105 may comprise sheets, such as polygonal metal sheets connected together to form a housing for electrical circuitry (not shown). The electrical circuitry may comprise one or more sensors, computerized memory and a control unit for managing the processes discloses herein. The control unit may control the vehicle's navigation, landing, tasks, communication and the like.

The body 105 is coupled to a set of wheels, such as wheels 120, 125. The wheels may be coupled to driving actuators configured to provide power to the wheels. The driving actuators are coupled to a power source such as a battery. The wheels 120, 125 are configured to roll on top of a surface, for example a sloped surface, such as windows, panels, solar panels, helicopter's blades, windmill blades and the like. The body 105 is coupled to a set of propellers 140, 142, 145 and 148. The propellers 140, 142, 145 and 148 may be placed symmetrically relative to the body, for example two propellers in a front section of the body 105 and two propellers in a rear section of the body 105. In some cases, only a portion of the propellers 140, 142, 145 and 148 are activated in a given time stamp, for example when [David, can you provide a scenario?]. The propellers 140, 142, 145 and 148 are capable of generating thrust force at a specific direction. Upward direction is defined as direction towards an upper end of the body 105, while downward direction is defined as direction towards an upper end of the body 105. When the body 105 is in a standard orientation, having the wheels 120, 125 lower than the body 105, downward thrust pushes the body 105 downwards, for example towards a surface at which the body 105 stands.

The direction of the propellers' thrust may be influenced by the rotation direction of the propellers' blades, or from an angle between the propellers' blades and an arm connecting the propellers 140, 142, 145 and 148 to the body. This angle is also called pitch angle or blade angle. The direction of the propellers' thrust may be determined by the control unit, or from a remote device such as a server communicating with the vehicle 100, or automatically according to a set of rules.

The vehicle 100 may be configured as a cleaning robot. As such, the vehicle 100 may comprise one or more brushes 130, 135 configured to clean a surface on which the vehicle 100 moves, such as a window or a panel. The brushes 130, 135 may roll around an axis coupled to the body 105.

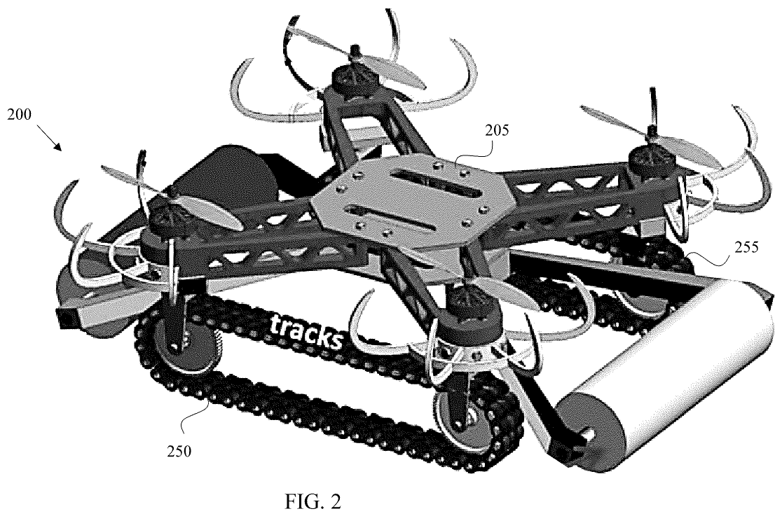

FIG. 2 shows a flying driving vehicle capable of moving on a sloped surface using tracks, according to exemplary embodiments of the present invention. The functionality of the vehicle 200 is substantially similar to the vehicle 100 of FIG. 1, only that the vehicle 200 comprises tracks configured to be in physical contact with a surface. The vehicle 200 may comprise a single track located along a longitudinal axis of the body 205, or multiple tracks. FIG. 2 shows two tracks 250, 255 placed on two sides on a bottom section of the body 205 of the vehicle 200. The tracks 250, 255 may move in response to a command from a control unit, at specific speed and direction.

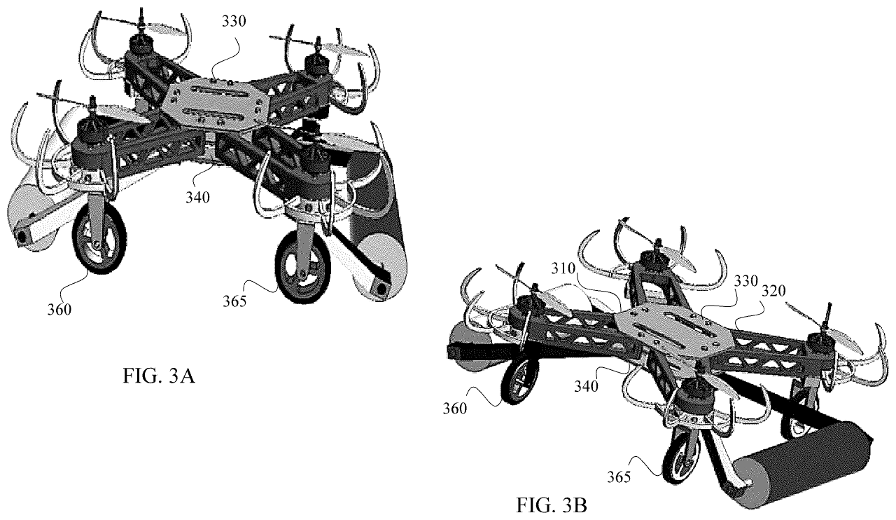

FIGS. 3A-3B show a flying driving vehicle capable of moving on a sloped surface using wheels at various directions, according to exemplary embodiments of the present invention. In FIG. 3A, the wheels 360, 365 move along a longitudinal axis of the body, extending from a front section 310 to a rear section 320 of the body. In FIG. 3B, the wheels 360, 365 move on a lateral axis, perpendicular to a longitudinal axis of the body. The lateral axis extending on an imaginary line between a right section 340 to a left section 330 of the body. The wheels' direction may change using joints, axes and other mechanisms connecting the wheels 360, 365 to the vehicle's body. The wheels' direction may change in response to a command from the control unit or from a command from a remote device.

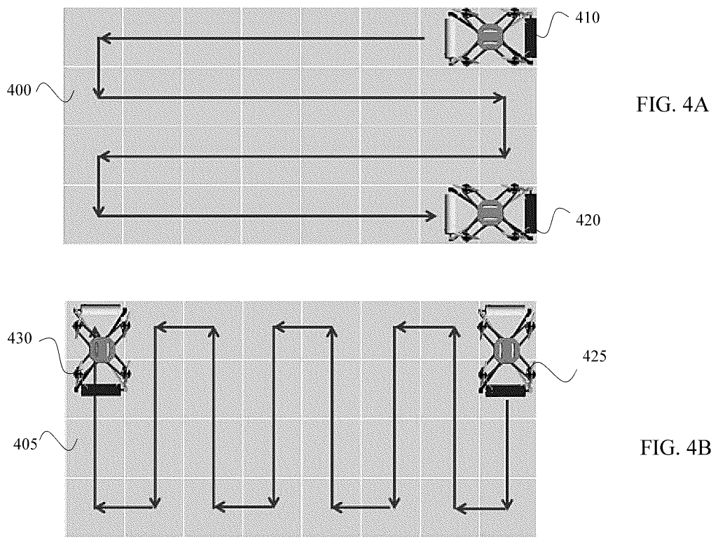

FIGS. 4A-4B show a flying driving vehicle capable of moving on a sloped surface using wheels at various patterns, according to exemplary embodiments of the present invention. In FIG. 4A, the vehicle 410 begins on a top right corner of the panel 400 and moves horizontally to the top left corner when it moves downwards and then horizontally to the right, until the vehicle takes off at bottom right corner 420. In FIG. 4B, the vehicle 425 begins on a top right corner of the panel 405 and moves downwards to the bottom right left corner when it moves horizontally to the left and then upwards, until the vehicle takes off at top left corner 430. The robot can fly from its base and land on surfaces. In order to avoid driving or flipping over when driving on the panels, the robot reverses the propellers thrust direction, increasing the normal and friction forces with the surface. After landing on the surface, the robot maintains the rotation of its propellers and drives along the surface.

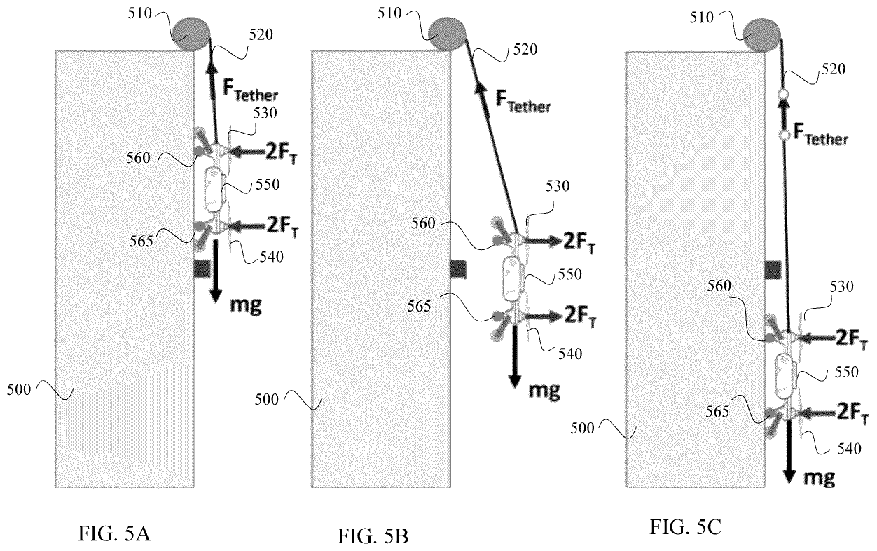

FIGS. 5A-5C show a flying driving vehicle coupled to a tether when cleaning a building, according to exemplary embodiments of the present invention. For cleaning building facets, the vehicle 550 can be tethered to the building 500. The tether 520 supports the vehicle's weight and provides safety in case the vehicle 550 loses control so that it does not crash near the building 500. The tether 520 can also be used to provide the vehicle 500 with electricity, transfer data and supply cleaning liquids. In FIG. 5A, the vehicle 550 is tethered to the building 500 and its propellers 530, 540 provide negative thrust which increase the vehicle's contact force with the building 500. At this point, the vehicle 550 can drive to clean the window. The vehicle 550 can move vertically by shortening the tether 520 sideways by driving the wheels 560, 565 and/or by moving the vehicle's anchor to the building. In case the vehicle 550 is required to move from one window to another while skipping over window frames, the vehicle 550 can turn on its propellers 530, 540 to produce positive thrust to distance the vehicle 550 from the building 500, as shown in FIG. 5B. The vehicle 550 may then move horizontally and/or vertically by changing the length of the tether 520 and moving the anchor. After skipping to another window, the vehicle 550 reverses the propellers 530, 540 to stick back to the window, as shown in FIG. 5C.

In some cases, the tether 520 can hold the entire weight of the vehicle 550. In some cases, the tether 520 may be used to supply the vehicle with electricity, control commands, sensor data, cleaning liquids and additional materials. The vehicle may be coupled to more than one tether concurrently. The length of the tether 520 may vary, for example using pulling mechanisms. The pulling may be executed in response to a command from the vehicle's controller, a command from a remote device and the like.

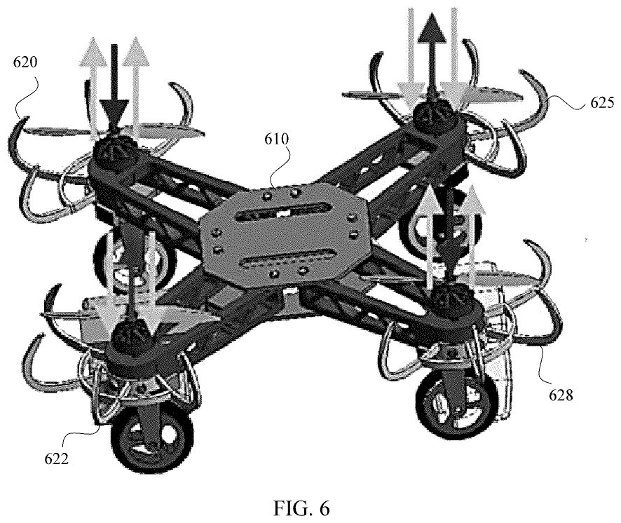

FIG. 6 shows a flying driving vehicle producing both positive and negative thrust, according to exemplary embodiments of the present invention. The vehicle comprises a body 610 and a set of four propellers 620, 622, 625 and 628 located on substantially four corners areas of the body 610—propeller 620 is at the front right area, propeller 622 is at the front left area, propeller 625 is at the rear right area, propeller 628 is at the rear left area. The vehicle's propellers 620, 622, 625 and 628 may be used to clean sand or dust, for example by rotating two propellers 620, 622 to produce negative thrust and two other propellers 625, 628 to produce lift. This way, the vehicle may produce enough wind towards the bottom in order to clear the sand, for example from a solar panel.

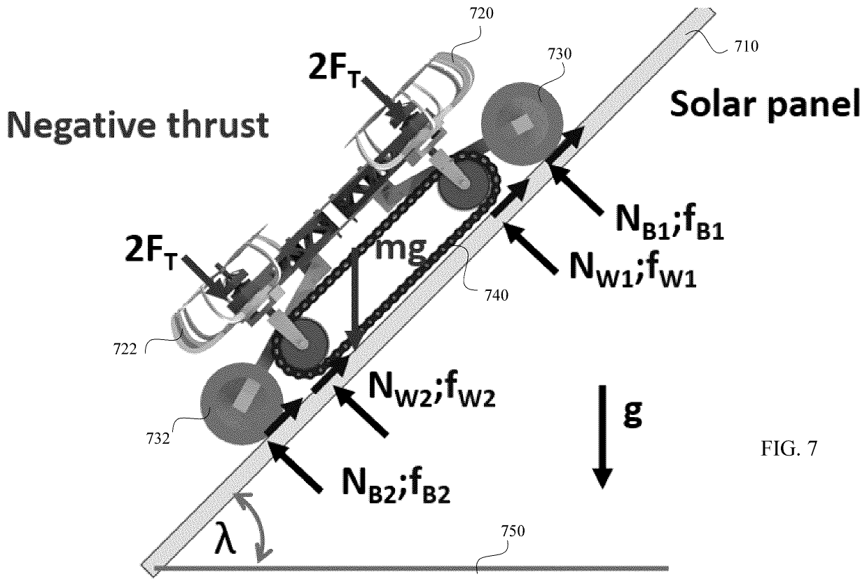

FIG. 7 shows a flying driving vehicle having a force sensor, according to exemplary embodiments of the present invention. The flying driving vehicle may also comprise a torque sensor configured to measure torque, and optionally a torque transducer configured to convert torque into an electrical signal.

A force sensor is defined as a transducer that converts an input mechanical load, weight, tension, compression, or pressure into an electrical output signal (load cell definition). Force Sensors are also commonly known as force transducers. The forces may include tensile, gravitational, torque, normal, compressive forces, and a combination of the above. The force sensors may collect measurements of six degrees of freedom.

The flying driving vehicle is configured to move along an inclined surface 710 having an inclination angle (a) relative to the ground 750.

The flying driving vehicle comprises propellers 720 and 722. The propellers may comprise one or more propellers, for example, a pair of front propellers and a set of rear propellers.

The flying driving vehicle may comprise brushes 730 and 732 placed on opposite sides of the flying driving vehicle.

The flying driving vehicle comprises tracks 740 configured to enable the vehicle to move along the surface 710.

The force sensors coupled to the vehicle measure forces applies to the vehicle. The forces include a normal to the surface 710 and a friction force in a tangential direction, parallel to the surface 710.

For a given inclination angle and friction coefficient, the energy required to keep the vehicle in place and prevent the vehicle from sliding on the inclined surface is a function of the propellers' force. The propellers' force is a function of the propellers' rotational speed. As the propellers 720 and 722 rotate at a higher speed, the normal forces increase together with the vehicle's energy consumption and the noise produced by the propellers 720 and 722. In order to minimize the energy consumption and noise, it is desired to minimize the propellers' rotational speed and normal forces, while ensuring that the vehicle does not slide downwards along the surface 710.

The main forces acting on the robot are the weight, the normal forces on its wheels/tracks, the forces acting on the brush and the forces that the robot generates from the propellers. Measuring the forces acting on the brush and analyzing them allows calculating more precisely the negative thrust forces that the propellers are required to apply in order to keep the robot attached to the surface. The brush when actuated may produce normal forces that disconnect the robot from the surface and tangential forces that may add up to the weight components causing the robot to slide. The propellers must apply sufficient forces which produce enough normal forces to keep the robot attached to the surface and sufficient normal contact force that is necessary to produce friction between the wheels or tracks and the surface in order to counter the weight component and the tangential friction forces that the brush produce as it cleans the surface.

In another aspect of the invention a method is provided, comprising: placing an flying driving vehicle in physical contact with an inclined surface having an inclination angle relative to the ground, using sensors placed in or coupled to the flying driving vehicle to collect measurements that represent forces applied on the flying driving vehicle when the flying driving vehicle is in physical contact with an inclined surface, based on the measurements, calculating the negative thrust forces that the propellers are required to apply in order to keep the flying driving vehicle attached to the surface. Then, the method comprises moving the propellers at a rotational speed that matches the negative thrust.

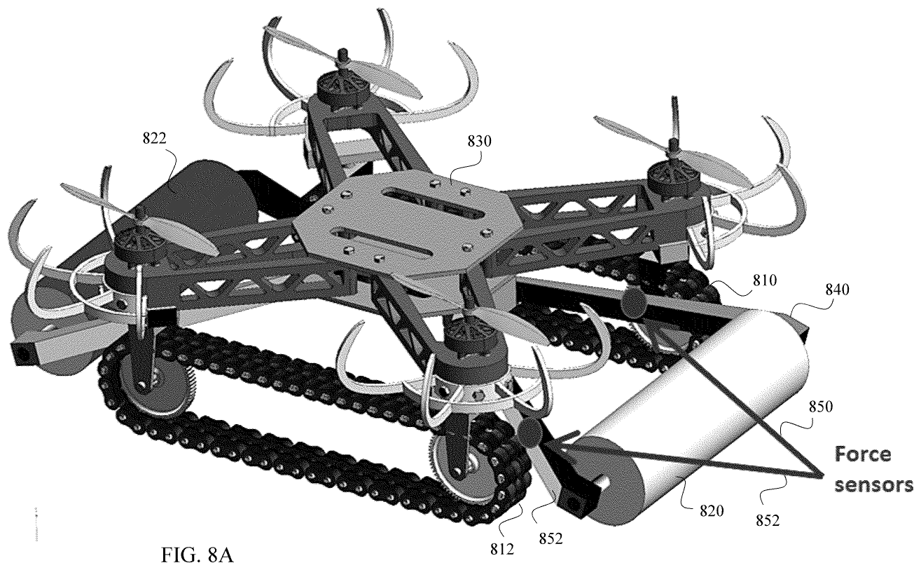

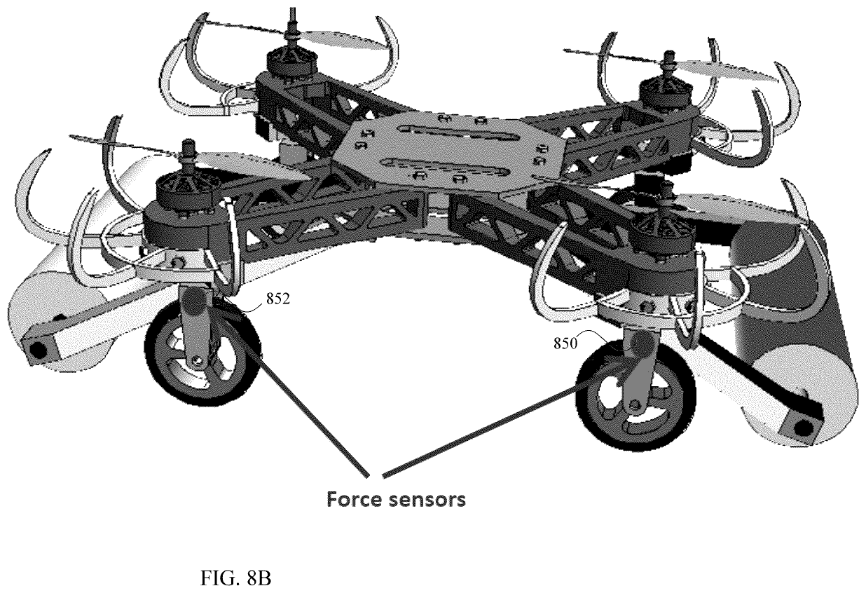

FIGS. 8A-8B show a flying driving vehicle having a force sensor coupled to the longitudinal arms of the vehicle, according to exemplary embodiments of the present invention. The longitudinal arms 840 and 842 connect the brushes 820 and 822 to the body of the vehicle. The body is configured to carry the circuitry 830 that processes the measurements of the force sensors 850 and 852.

In the exemplary embodiment of FIGS. 8A and 8B, the force sensors 850, and 852 enable measuring the forces acting on the brushes 820, 822 respectively, and evaluate the components of the forces that the surface applies in parallel to the surface (tangential direction) and normal to the surface (vertical direction). The ratio of the tangential forces divided by the normal forces (relative to the surface) allows calculating the friction coefficient of the surface that the drone moves along. The friction coefficient is then used to estimate the cleanliness of the surface and determine the forces required to be provided by the propellers to keep the vehicle in physical contact with the surface.

FIG. 8B shows an exemplary embodiment in which the sensors 850 and 852 measure the torque acting on the brushes 820 and 822. This can be implemented using the force and torque sensor for example or using the power current, in order to estimate the friction coefficient between the brushes with the surface. The friction force generally increases together with the speed of rotation but also as a function of the friction allowing estimating the coefficient of friction between the brush with the surface.

Force sensors can be placed between the robot's body and its wheels allowing to measure in real-time the normal and tangential forces acting on the track in order to increase or decrease the forces produced by the propellers. For example, if the friction forces between the track/wheels and the surface are too small, which may cause slippage, the propellers' speed can be increased in order to increase sticking with the surface.

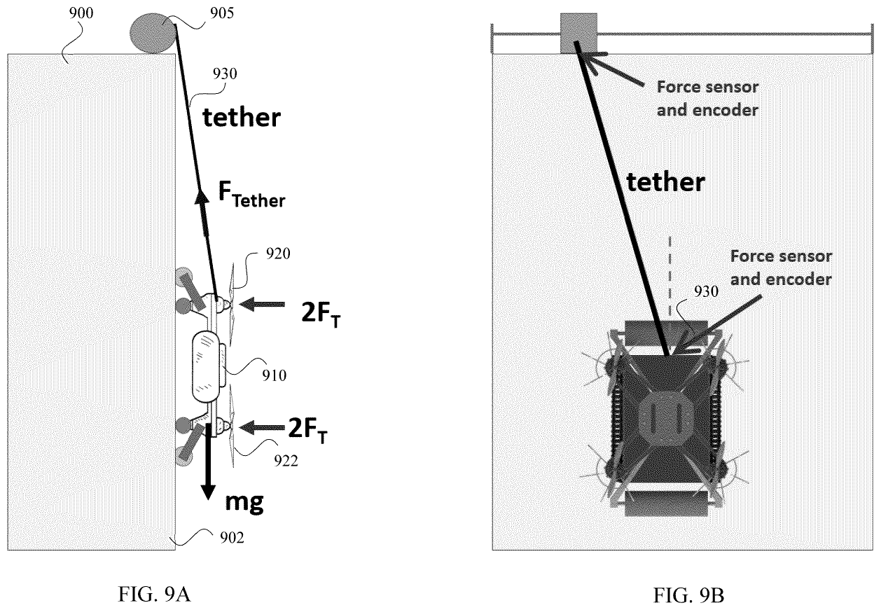

FIGS. 9A-9B show a flying driving vehicle hanging from a tether, according to exemplary embodiments of the present invention. The tether 930 may be physically coupled to an upper surface 900 of a building or be physically coupled to a weight 905 placed on the upper surface 900. The weight may be coupled to a pulley (not shown) configured to pull the tether 930 or lengthen the tether 930 based on commands, for example from the controller of the flying driving vehicle. The vehicle has electrical circuitry 930 that comprises at least a processor and memory for storing instructions to be performed by the processor. The vehicle comprises propellers 920 and 922 for pushing the vehicle towards the surface 902.

When hanging on from the top surface 900 of a building or structure and driving on the facet of the building, the forces acting on the vehicle are its weight, the tether force (or tension force in the tether), the normal and tangential forces acting on the wheels/tracks of the vehicle applied by the building and the forces that the propeller 920 and 922 apply. In order to reduce energy consumption by the vehicle's battery, the vehicle can rely on the tether 930 to fully or partially hold the vehicle's weight while the remainder of the force can be generated by friction forces between the vehicle's track/wheel and the building's surface 902. A force sensor placed along the attachment will allow measuring the force (tension) that the tether 930 applies on the vehicle. An encoder can also be based on the same joint to detect the direction in which the force is applied. Using the two forces, it is possible to determine more precisely the required forces that the propellers 920 and 922 are required to provide in order to keep the vehicle in physical contact with the surface 902.

The tether 930 may be attached to the vehicle on one side and to a mobile actively actuated tether mechanism on the other side. The mechanism can allow to an increase or decrease in the length of the tether 930. The actuated tether mechanism can move along a horizontal track or cable allowing the tether 930 to move horizontally from one side to another side of the building. Using the actuated tether mechanism, the tether 930 attached to the vehicle can move and remain substantially above the vehicle, to increase the vertical force applied by the tether and in parallel reduce the friction forces that the vehicle must apply on the surface 903 to remain attached to the wall.

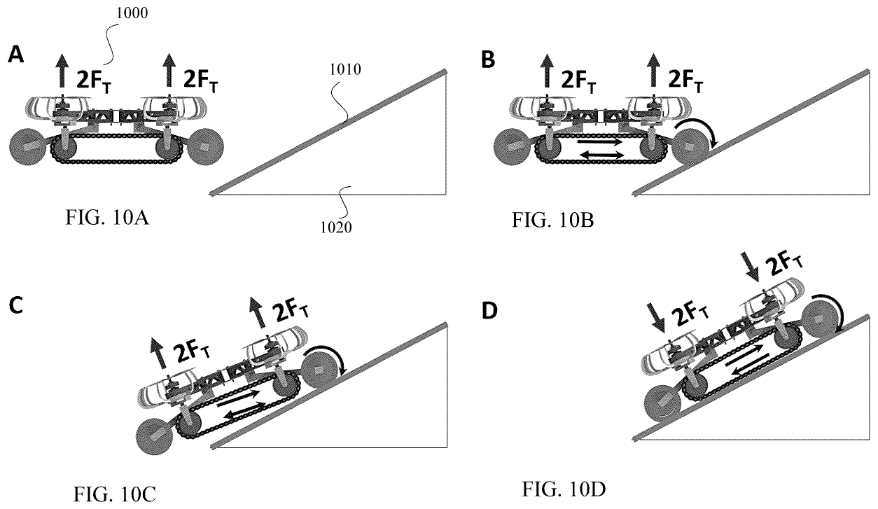

FIGS. 10A-10D show a flying driving vehicle landing on an inclined surface, according to exemplary embodiments of the present invention. Unlike regular landings of drones which land vertically, the landing of the flying driving vehicle described herein can be performed in a new method. In FIG. 10A, the vehicle can fly nearly horizontally until the vehicle is in physical contact with the tilted surface 903. In FIG. 10B, when the vehicle is in physical contact with the surface 903 or shortly before, the vehicle actuates its brushes and/or the vehicle's wheels/tracks to start climbing upwards along the slope of the surface as the drone continues flying horizontally. The combination of flying horizontally together with the actuation of the vehicle's wheels/tracks allows for a smoother landing on the surface. In FIG. 10D, the vehicle fully contacts the surface with all its wheels or tracks, and the vehicle can reverse its propellers, stick to the surface and avoid sliding downwards.

Alternatively, after initially contacting the surface with the vehicle's tracks or wheels, the vehicle may reverse its front propellers in order to increase the force it applies at the contact point. The vehicle continues driving forward until all its wheels or track contact the surface. At this stage, the rotation of the back propellers will be inverted.

It should be understood that the above description is merely exemplary and that there are various embodiments of the invention that may be devised, mutatis mutandis, and that the features described in the above-described embodiments, and those not described herein, may be used separately or in any suitable combination; and the invention can be devised in accordance with embodiments not necessarily described above.

While the disclosure has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings without departing from the essential scope thereof. Therefore, it is intended that the invention is not limited to the particular embodiments described herein.

What is claimed is:

1. A flying driving vehicle, comprising:
a body;
a driving interface coupled to the body, configured to enable the body to drive on an inclined surface and a driving actuator configured to provide power to the driving interface;
a set of propellers coupled to the body, wherein the propellers' movement keep the vehicle in place when the inclined surface is inclined relative to the ground;
force sensors configured to collect measurements that represent forces applied on the flying driving vehicle when the flying driving vehicle is in physical contact with the inclined surface; and
a controller for controlling the speed of the driving interface, a rotation speed of the set of propellers and a magnitude and direction of thrust applied by the set of propellers.

2. The flying driving vehicle of claim 1, wherein the driving interface is a caterpillar track.

3. The flying driving vehicle of claim 1, wherein the driving interface is a set of wheels.

4. The flying driving vehicle of claim 1, further comprising a cleaning module coupled to the body.

5. The flying driving vehicle of claim 4, wherein the cleaning module comprises one or more rotating brushes.

6. The flying driving vehicle of claim 4, wherein the cleaning module comprises one or more brushes that move linearly along the inclined surface.

7. The flying driving vehicle of claim 4, wherein the force sensor detects a normal force applied to the cleaning module when the cleaning module is in physical contact with the inclined surface.

8. The flying driving vehicle of claim 1, further comprising a motion sensor for collecting movement measurements of the aerial vehicle when in contact with the surface, wherein the controller sets a speed of the set of propellers according to the collected measurements, the propellers' movement prevents the driving interface from sliding from the surface.

9. The flying driving vehicle of claim 1, further comprising a the set of propellers actuators, each propeller actuator of the set of propeller actuator is coupled to the controller and outputs power according to a command from the controller.

10. The flying driving vehicle of claim 1, further comprising a tether coupled to the body for securing the flying driving vehicle to another object, wherein the force sensors also collect measurements of a tensional force applied by the tether on the flying driving vehicle.

11. The flying driving vehicle of claim 1, wherein the propellers' movement allows the vehicle to drive without sliding.

12. The flying driving vehicle of claim 1, wherein the tether is a tube capable of carrying an object selected from liquids, power supply, cleaning equipment, communication equipment and a combination thereof.

13. The flying driving vehicle of claim 1, wherein at least some of the propellers in the set of propellers are used for flying the vehicle and applying the negative thrust.

14. The flying driving vehicle of claim 1, wherein the force sensors are placed between the robot's body and the driving interface.

15. A method for controlling a flying driving vehicle having propellers and moving on an inclined surface, the method comprising:
placing the flying driving vehicle in physical contact with the inclined surface having an inclination angle relative to the ground;
using force sensors coupled to the flying driving vehicle to collect measurements that represent forces applied on the flying driving vehicle when the flying driving vehicle is in physical contact with an inclined surface;
based on the measurements, calculating negative thrust forces that the propellers are required to apply in order to keep the flying driving vehicle attached to the inclined surface; and
moving the propellers at a rotational speed that matches the negative thrust.

16. The method of claim 15, further comprises evaluating components of the forces that the inclined surface applies in parallel to the inclined surface (tangential direction) and normal to the inclined surface (vertical direction).

17. The method of claim 16, further comprises computing a ratio of the tangential forces divided by the normal forces and calculating a friction coefficient of the inclined surface based on the ratio.

18. The method of claim 17, further comprises estimating a cleanliness level of the inclined surface according to the friction coefficient.

19. The method of claim 17, further comprises determining forces required to be provided by the propellers to keep the flying driving vehicle in physical contact with the inclined surface.

20. The method of claim 17, further comprises increasing the propellers' speed in case the friction forces between the track/wheels and the inclined surface are too small.
